(19) United States
(12) Patent Application Publication
(10) Pub. No.: US 2005/0095366 A1
(43) Pub. Date: May 5, 2005

(54) Method of conformal coating using noncontact dispensing

(76) Inventors: Liang Fang, San Diego, CA (US); Horatio Quinones, Carlsbad, CA (US)

Correspondence Address: WOOD, HERRON & EVANS, LLP (NORDSON), 2700 CAREW TOWER, 441 VINE STREET, CINCINNATI, OH, 45202, US

(21) Appl. No.: 10/698,859

(22) Filed: Oct. 31, 2003

(51) Int. Cl. B05D 1/02

(52) U.S. Cl. 427/421.1

(57) ABSTRACT

A method of noncontact dispensing is provided for conformal coating applications by jetting a viscous material onto a substrate. Dispensing by a jetting process results in small wetted areas thus providing highly discrete and selective conformal coating capabilities. Enhanced selectivity permits the coating of small areas and geometries and provides excellent edge definition between coated and uncoated areas.

### FIELD OF THE INVENTION

The present invention generally relates to dispensing viscous materials and more particularly, to a method for dispensing minute amounts of viscous materials for applying conformal coatings to electrical components.

### BACKGROUND OF THE INVENTION

Conformal coating is the process of applying a dielectric material onto an electrical component, for example, a printed circuit (PC) board or a device mounted thereon, to protect it from moisture, fungus, dust, corrosion, abrasion and other environmental stresses. Common conformal coating materials include, by way of example and not by limitation, silicone, acrylic, polyurethane, epoxy synthetic resins and various polymers. When applied to PC boards, an insulative resin film of generally uniform thickness is formed as a solvent evaporates or, as a solvent free material is cured. Several different processes are known for applying conformal coating including dip coating, brush application, atomized air spray, and others. Due to the non-selective nature of many of these methods, conformal coating processes often require a mask to be applied to the board or component to prevent coating in undesirable areas. Masking is often done manually which leads to higher production costs and reduced product output. More current applications utilize automated processes, such as a robot, to apply conformal coatings. Major improvement in the conformal coating process can be realized through the use of automated systems that apply coating to selected areas of the PC board and the components thereon in order to preserve electrical and/or thermal properties on specific uncoated areas. These selective coating systems have a dispenser mounted to a robot that is programmed to move and dispense material in designated locations on the PC board.

Automated selective coating systems are known which have conformal coating dispensers that dispense material in various patterns, with varying deposition accuracies and producing coatings with varying thicknesses. For instance, a dispenser may dispense material in the form of a straight bead, a bead that is continuously rotated in a curved or circular pattern, and/or a bead that is atomized. Beads tend to produce coatings that are generally thicker than those for atomized sprays. Furthermore, depending on material viscosities as well as material/board surface tension interactions, a bead deposited on a board may spread to locations where no coating is desired. Moreover, in atomized sprays, injecting a supply of material with pressurized air to achieve atomization often creates significant overspray, thus depositing atomized droplets outside a target area.

These current dispensing methods have features that in some applications lead to undesirable coating results including greater than desirable minimum coating areas and less than desirable edge definition capability. In some conformal coating applications, it is desirable to have the capability to coat rather small areas or small geometries. This capability, however, primarily depends on the type of dispenser used to apply the coating material and perhaps more specifically, the control a dispenser provides over the dispensed material. In current dispensers, such as those that dispense beads or atomized sprays, there is a limit to which the size of the wetted area, or contact area of the bead or spray on a component, can be minimized. As a result, current dispensers have minimum coating areas, i.e., an area where it is practical to use such a dispenser for conformal coating applications, which may be too large for some current applications. This becomes even more significant as boards and components get smaller and component densities on such boards increase.

The miniaturization of PC boards and related components also makes edge definition between coated and uncoated portions of an area more important. With known dispensers, masking is often used to cover the portions of the board where no coating is desired. This is a time consuming and inefficient way to prevent the coating of certain areas. While conventional dispensers in selective coating machines decrease the need for masking, the edge definition between the coated and uncoated areas is often insufficiently sharp. As mentioned, it can be difficult to precisely control the location of a coating edge when using a bead dispenser. Temperature-dependent viscosities as well as surface tension effects make it difficult to predict how far the relatively thick layer of coating material will spread. In spray applications, the atomization process disperses a stream into a collection of droplets. This process can be difficult to control and often results in a significant number of satellite droplets that land outside a target area. This gives the edge between the coated and uncoated areas a rather ragged look.

Therefore, there is a need to constantly improve the accuracy and selectivity of material deposition to conformal coat a substrate such as a P.C. board or a device thereon.

### SUMMARY OF THE INVENTION

The present invention provides methods of noncontact dispensing for conformal coating applications by jetting a viscous conformal coating material onto a substrate. The methods of the present invention provide enhanced control of the dispensed material such that the wetted area, or contact area of the dispensed material, is minimized to provide highly discrete and selective conformal coating capabilities. Moreover, the enhanced ability to control the contact area of the dispensed material then makes it possible to coat smaller areas and geometries than could be coated with previous processes without masking. The increased selectivity of the present invention permits only the reverse of the solder mask, that is, the solder joints to be coated, thereby resulting in substantial savings in material, machine processing time, and labor and thus, reducing production costs as well as product cost.

The methods of viscous material noncontact dispensing of the present invention further eliminate overspray and provides excellent edge definition between coated and uncoated areas without the need for masking. Eliminating overspray reduces machine contamination, thereby reducing maintenance costs in both time and material.

In one aspect of the invention, the substrate has an electrical device mounted thereon. The method requires moving the jetting valve with respect to the substrate; and while moving the jetting valve, applying droplets of conformal coating material to the surface of the substrate and the device by iteratively causing the jetting valve to propel a flow of the conformal coating material through the nozzle with a forward momentum, and breaking the flow of the conformal coating material using the forward momentum to form a droplet of the conformal coating material.

In a further aspect of the invention, the substrate has solder contacts thereon. The method further requires moving the jetting valve with respect to the substrate; and while moving the jetting valve, applying droplets of conformal coating material to the solder contacts by iteratively causing the jetting valve to propel a flow of the conformal coating material through the nozzle with a forward momentum, and breaking the flow of the conformal coating material using the forward momentum to form a droplet of the conformal coating material.

According to the principles of the present invention and in accordance with the described embodiments, the invention provides a method of noncontact dispensing a conformal coating material onto a surface of a substrate. The method uses a positioner supporting a jetting valve to move the jetting valve with respect to the substrate. While the jetting valve is moving, droplets of conformal coating material are applied to the surface of the substrate by iteratively causing the jetting valve to propel a flow of the conformal coating material through the nozzle with a forward momentum and breaking the flow of the conformal coating material using the forward momentum to form a droplet of the conformal coating material.

These and other objects and advantages of the present invention will become more readily apparent during the following detailed description taken in conjunction with the drawings herein.

### BRIEF DESCRIPTION OF THE DRAWINGS

FIG. 1 is a schematic representation of a computer controlled, noncontact, viscous material jetting system providing jetting of a conformal coating material in accordance with the principles of the present invention.

FIG. 2 is a schematic block diagram of the computer controlled, noncontact, viscous material jetting system of FIG. 1.

FIG. 3 is a perspective view of a PC board illustrating a selective conformal coating of components mounted to the board.

### DETAILED DESCRIPTION

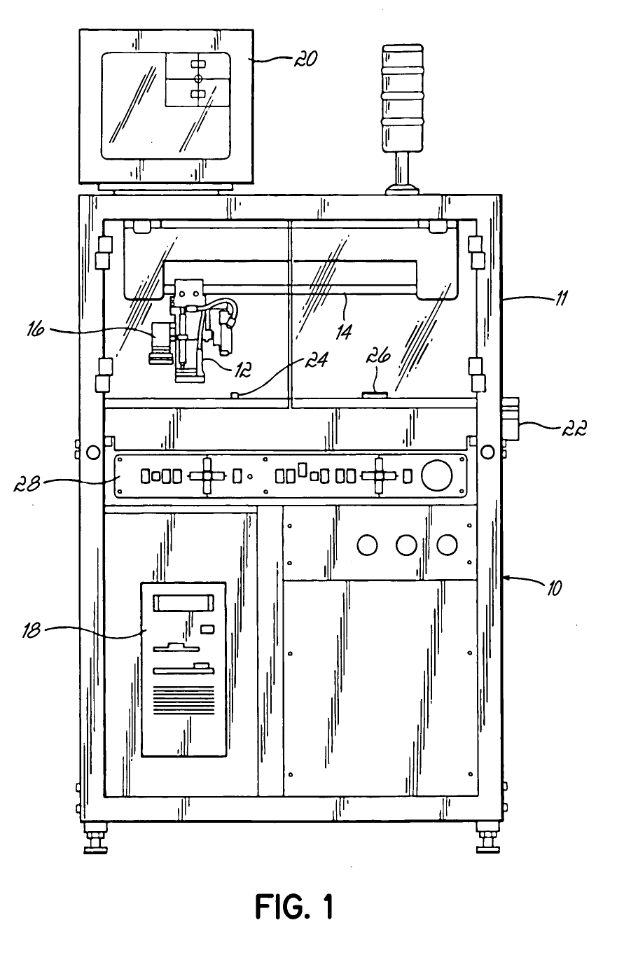

FIG. 1 is a schematic representation of a computer controlled noncontact viscous material jetting system 10, for example, an “AXIOM” X-1020 series commercially available from Asymtek of Carlsbad, Calif. A droplet generator 12 is mounted on a Z axis drive that is suspended from an X, Y positioner 14 in a known manner. The X, Y position 14 is mounted on a frame 11 and defines first and second nonparallel axes of motion. The X, Y positioner includes a cable drive coupled to a pair of independently controllable stepper motors (not shown) in a known manner. A video camera and LED light ring assembly 16 are connected to the droplet generator 12 for motion along the X, Y and Z axes to inspect dots and locate reference fiducial points. The video camera and light ring assembly 16 may be of the type described in U.S. Pat. No. 5,052,338 entitled “APPARATUS FOR DISPENSING VISCOUS MATERIALS A CONSTANT HEIGHT ABOVE A WORKPIECE SURFACE”, the entire disclosure of which is incorporated be reference herein.

A computer 18 provides overall system control and may be a programmable logic controller (“PLC”) or other microprocessor based controller, a hardened personal computer or other conventional control devices capable of carrying out the functions described herein as will be understood by those of ordinary skill. A user interfaces with the computer 18 via a keyboard (not shown) and a video monitor 20. The computer 18 is provided with standard RS-232 and SMEMA CIM communications busses 50 which are compatible with most types of other automated equipment utilized in substrate production assembly lines.

A substrate (not shown) with devices mounted thereon onto which conformal coating material, such as a silicone, acrylic or polyurethane resin, is to be applied is located directly beneath a droplet generator 12. The substrate can be manually loaded or transported by an automatic conveyor 22. The conveyor 22 is of conventional design and has a width which can be adjusted to accept PC boards of different dimensions. The conveyor 22 also includes pneumatically operated lift and lock mechanisms. This embodiment further includes a nozzle priming station 24 and a nozzle calibration set-up station 26. A control panel 28 is mounted on the frame 11 just below the level of the conveyor 22 and includes a plurality of push buttons for manual initiation of certain functions during set-up, calibration and viscous material loading.

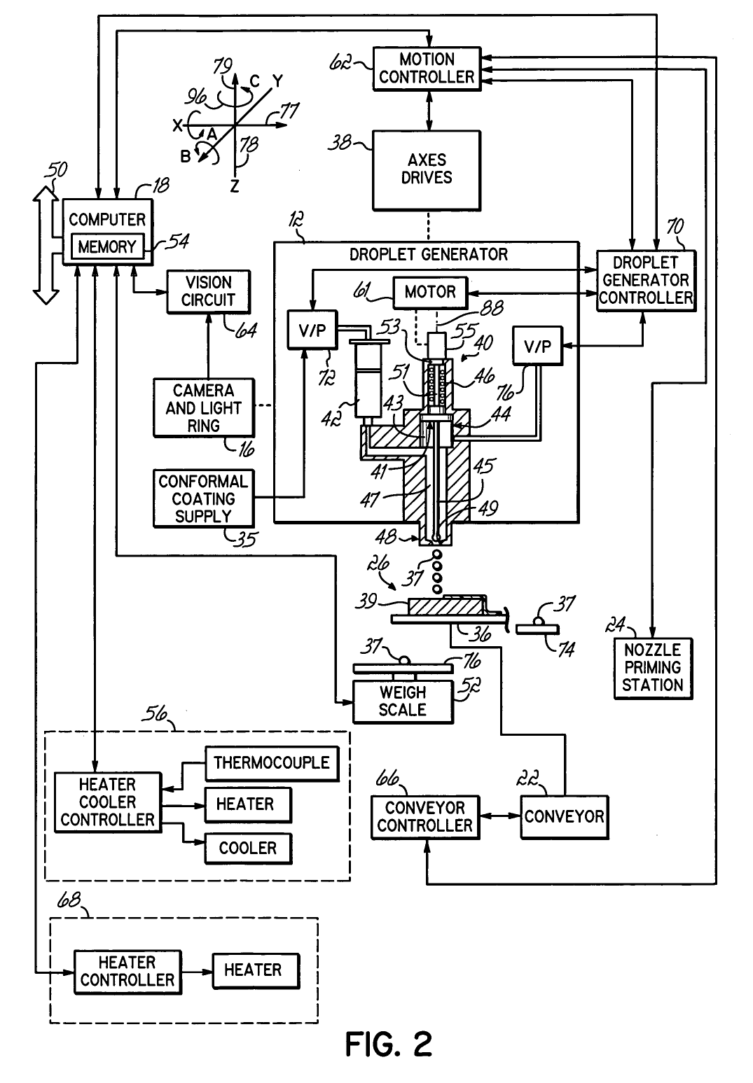

Referring to FIG. 2, the droplet generator 12 is shown ejecting droplets 37 of conformal coating material onto a substrate 36, for example, a PC board, that supports an electrical component 39, for example, a semiconductor chip or die, etc. The PC board 36 is of the type designed to have components surface mounted thereon. The PC board is moved to a desired position by the conveyor 22.

The axes drives 38 often include the X, Y positioner 14 (FIG. 1) and a Z axis drive system, which are capable of rapidly moving a jetting dispenser 40 along X, Y and Z axes 77, 78, 79, respectively, with respect to the PC board 36. The droplet generator 12 can eject droplets of conformal coating material from one fixed Z height, or the droplet generator 12 can be raised under program control during a cycle of operation to dispense at other Z heights or to clear other components mounted on the board.

The droplet generator 12 includes an ON/OFF dispenser 40 which is a non-contact dispenser specifically designed for jetting minute amounts of viscous materials, such as conformal coating material. The dispenser 40 has a jetting valve 44 with a piston 41 disposed in a cylinder 43. The piston 41 has a lower rod 45 extending therefrom through a material chamber 47. A distal lower end of the lower rod 45 is biased against a seat 49 by a return spring 46. The piston 41 further has an upper rod 51 extending therefrom with a distal upper end that is disposed adjacent a stop surface on the end of a screw 53 of a micrometer 55. Adjusting the micrometer screw 53 changes the upper limit of the stroke of the piston 41. The dispenser 40 may include a syringe-style supply device 42 that is fluidly connected to a supply of conformal coating material 35 in a known manner. A droplet generator controller 70 provides an output signal to a voltage-to-pressure transducer 72, for example, a pneumatic solenoid connected to a pressurized source of fluid, that, in turn, ports pressurized air to the supply device 42. Thus, the supply device 42 is able to supply pressurized conformal coating material to the chamber 47.

A jetting operation is initiated by the computer 18 providing a command signal to the droplet generator controller 70, which causes the controller 70 to provide an output pulse to a voltage-to-pressure transducer 76, for example, a pneumatic solenoid connected to a pressurized source of fluid. The pulsed operation of the transducer 76 ports a pulse of pressurized air into the cylinder 43 and produces a rapid lifting of the piston 41. Lifting the piston lower rod 45 from the seat 49 draws conformal coating material in the chamber 47 to a location between the piston lower rod 45 and the seat 49. At the end of the output pulse, the transducer 76 returns to its original state, thereby releasing the pressurized air in the cylinder 43, and a return spring 46 rapidly lowers the piston lower rod 45 back against the seat 49. In that process a droplet 37 of conformal coating material is rapidly extruded or jetted through an opening or dispensing orifice 49 of a nozzle 48. As schematically shown in exaggerated form in FIG. 2, a very small conformal coating material droplet 37 breaks away as a result of its own forward momentum and is deposited as a dot of conformal coating material on the substrate 36. Successive operations of the cylinder 43 provide respective droplets of material 37. As used herein, the terms “jetting” refers to the above-described process for forming the conformal coating material droplets 37. The dispenser 40 is capable of jetting droplets from the nozzle 48 at very high rates, for example, up to 100 or more droplets per second. A line pattern of conformal coating material dots is formed on the substrate by the positioner 14 linearly moving the dispenser 40 while the dispenser 40 jets a plurality of droplets in rapid succession. A motor 61 controllable by the droplet generator controller 70 is mechanically coupled to the micrometer screw 53, thereby allowing the stroke of the piston 41 to be automatically adjusted, which varies the volume of conformal coating material forming each droplet.

The motion of the droplet generator 12 and the camera and light ring assembly 16 connected thereto, are governed by a motion controller 62. The motion controller 62 provides command signals to separate drive circuits for the X, Y and Z axis motors. A conveyor controller 66 is connected to the substrate conveyor 22. The conveyor controller 66 interfaces between the motion controller 62 and the conveyor 22 for controlling the width adjustment and lift and lock mechanisms of the conveyor 22. The conveyor controller 66 also controls the entry of the substrate 36 into the system and the departure therefrom upon completion of the dot deposition. In some applications, a substrate heating system 68 and/or a nozzle heating/cooling system 56 are operative in a known manner to heat the substrate and/or nozzle to maintain a desired temperature profile of the conformal coating material dots as the substrate is conveyed through the system.

The nozzle setup station 26 is used for calibration purposes to provide a dot size calibration for accurately controlling the weight or size of the dispensed droplets 37 and a dot placement calibration for accurately locating conformal coating material dots that are dispensed on-the-fly, that is, while the droplet generator 12 is moving relative to the substrate 36. In addition, the nozzle setup station is used to provide a material volume calibration for accurately controlling the velocity of the droplet generator 12 as a function of current material dispensing characteristics, the rate at which the droplets are to be deposited and a desired total volume of conformal coating material to be dispensed in a pattern of dots. The nozzle setup station 26 includes a stationary work surface 74 and a measuring device 52, for example, a weigh scale that provides a feedback signal to the computer 18 representing the weight of material weighed by the scale 52. Weigh scale 52 is operatively connected to the computer 18, which is capable of comparing the weight of the conformal coating material with a previously determined specified value, for example, a conformal coating material weight setpoint value stored in a computer memory 54. Other types of devices may be substituted for the weigh scale 24 and, for example, may include other dot size measurement devices such as vision systems, including cameras, LEDs or phototransistors for measuring the diameter, area and/or volume of the dispensed material. Prior to operation, a nozzle assembly is installed that is often of a known disposable type designed to eliminate air bubbles in the fluid flow path. Such a dispensing system is more fully described in pending provisional application Ser. No. 60/473,1616, entitled “Viscous Material Noncontact Dispensing System”, filed May 23, 2003, which is hereby incorporated by reference in its entirety herein.

In operation, CAD data from a disk or a computer integrated manufacturing (“CIM”) controller are utilized by the computer 18 to automatically assign dot sizes to specific components based on the user specifications or component library. Computer 18 then commands the motion controller 62 to move the droplet generator 12. This ensures that the minute dots of conformal coating material are accurately placed on the substrate 36 at the desired locations. In applications where CAD data is not available, the software utilized by the computer 18 allows for the locations of the dots to be directly programmed. In a known manner, the computer 18 utilizes the X and Y locations, the component types and the component orientations to determine where and how many conformal coating material dots to deposit onto the upper surface 80 of the substrate 36.

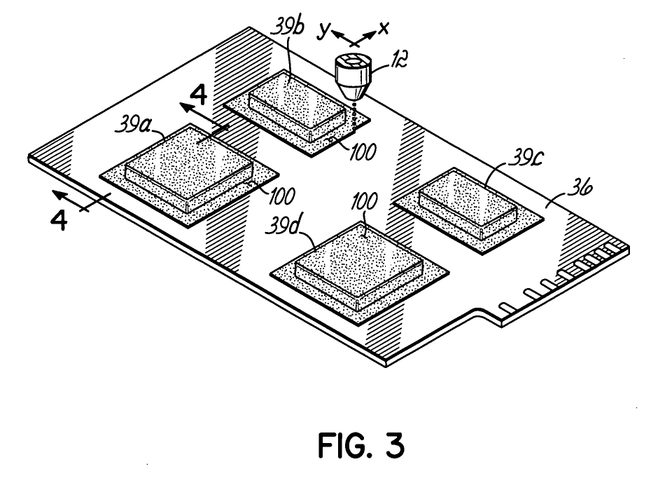

Referring to FIG. 3, a PC board 36 is shown having electrical devices 39a-39d mounted thereon for selective conformal coating. The computer 18 sends signals to motion controller 62 based on the board/device configuration as determined by computer 18. The motion controller 62 sends signals to the X, Y positioner 14 to move the jetting dispenser 40 along a path parallel to a first axis of motion, such as the X direction 77. While the dispenser 40 is being moved, the droplet generator controller 70 operates the jetting valve 44 to jet droplets 37 of conformal coating material in a linear pattern on one of the devices, for example, device 39b. After jetting a conformal coating along the first path, the motion controller 62 increments the dispenser 40 in a second axis of motion, such as the Y direction 78, and then, initiates motion back along the Y axis. Simultaneously, the motion controller 62 operates the jetting valve to apply a second linear pattern of conformal coating material adjacent to and contiguous with the first linear pattern. This process of applying linear patterns of conformal coating material is then repeated to provide a coated area 100 over the device 39b. The above process is further repeated to jet a conformal coating on the remaining devices 39a, 39c, 39d on the substrate 36.

The axes drives 38 often have X, Y and Z drives; however, as will be appreciated, in another embodiment, the dispenser 40 can be mounted on the Z axis positioner to be pivotable in a C axis 96, that is, a rotation about the Z axis 79. In a still further embodiment, the jetting dispenser can be mounted to be pivotable about either an A axis, that is, a rotation about the X axis 77 or, a B axis, that is, a rotation about the Y axis 78. Thus, the jetting dispenser can be manually set at an angle. Alternatively, in other embodiments, electric or fluid motors can be used to power one or more of the angles of rotation. Further, the electric and fluid motors can be placed under program control of the computer 16 or the motion controller 26. Examples dispensing systems having programmable axes of angular motion are shown and described in U.S. Pat. Nos. 6,447,847 and 5,141,165, which are hereby incorporated by reference in their entireties herein.

Jetting of conformal coating material onto a substrate has several advantages over existing conformal coating methods. One advantage, for example, is that jetting provides a small wetted area through the precise control of the volume of ejected droplets. The small wetted area of conformal coating dots allows for precise coating of small areas thus enhancing the selectivity of conformal coating systems. By precisely and selectively placing the conformal coating on a substrate without overspray, edge definition between coated and uncoated areas is enhanced. Further, by eliminating overspray, only the desired areas of the substrate are coated; and undesirable machine contamination is substantially reduced. Therefore, the need for masking is essentially eliminated, thereby reducing production and maintenance costs. Further, jetting the conformal coating material permits only the reverse of the solder mask, that is, the solder joints to be coated. The net result is a substantial savings in the conformal coating material used and thus, providing additional cost savings.

While the present invention has been illustrated by the description of one embodiment and while the embodiment has been described in considerable detail, it is not intended to restrict or in any way limit the scope of the appended claims to such detail. Additional advantages and modifications will readily appear to those skilled in the art. For example, in the described embodiment, only a single dispenser 40 is illustrated; however, as will be appreciated, in other embodiments, multiple dispensers on one or more positioners may be used to jet common or different conformal coating materials either sequentially or simultaneously.

The invention in its broader aspects is therefore not limited to the specific details shown and described. Accordingly, departures may be made from such details without departing from the scope or spirit of Applicant's claims which follow.

1. A method of noncontact dispensing a conformal coating material onto a surface of a substrate comprising:
providing a positioner supporting a jetting valve with a nozzle and being operable to move the jetting valve;
moving the jetting valve with respect to the substrate; and
while moving the jetting valve, applying droplets of conformal coating material to the surface of the substrate by iteratively
causing the jetting valve to propel a flow of the conformal coating material through the nozzle with a forward momentum, and
breaking the flow of the conformal coating material using the forward momentum to form a droplet of the conformal coating material.

2. The method of claim 1 wherein the substrate has an electrical device mounted thereon and the method further comprises:
moving the jetting valve with respect to the substrate; and
while moving the jetting valve, applying droplets of conformal coating material to the surface of the substrate and the device by iteratively
causing the jetting valve to propel a flow of the conformal coating material through the nozzle with a forward momentum, and
breaking the flow of the conformal coating material using the forward momentum to form a droplet of the conformal coating material.

3. A method of noncontact dispensing a conformal coating material onto solder contacts on a surface of a substrate comprising:
providing a positioner supporting a jetting valve with a nozzle and being operable to move the jetting valve in at least two axes of motion;
moving the jetting valve with respect to the substrate; and
while moving the jetting valve, applying droplets of conformal coating material to the solder contacts by iteratively
causing the jetting valve to propel a flow of the conformal coating material through the nozzle with a forward momentum, and
breaking the flow of the conformal coating material using the forward momentum to form a droplet of the conformal coating material.

4. A method of applying a conformal coating material to a surface, the method comprising:
providing a positioner supporting a jetting valve with a nozzle, the positioner being operable to move the jetting valve along X, Y and Z axes of motion;
moving the jetting valve along one of the X and Y axes of motion; and
while moving the jetting valve, creating droplets of the conformal coating material in a first linear pattern on the surface by iteratively
causing the jetting valve to propel a flow of the conformal coating material through the nozzle with a forward momentum,
breaking the flow of the conformal coating material using the forward momentum to form a droplet of the conformal coating material, and
applying the droplet of the conformal coating material to the surface of the substrate.

5. The method of claim 4 further comprising moving the jetting valve in a first angular axis of motion about one of the X, Y and Z axes of motion.

6. The method of claim 5 further comprising moving the jetting valve in a second angular axis of motion about another of the X, Y and Z axes of motion.

7. The method of claim 4 further comprising:
(a) moving the jetting valve through an increment along an other of the X and Y axes of motion;
(b) moving the jetting valve along the one of the X and Y axes of motion; and
(c) while moving the jetting valve, creating droplets of the conformal coating material in a second linear pattern on the substrate contiguous with the first linear pattern by iteratively
causing the jetting valve to propel a flow of the conformal coating material through the nozzle with a forward momentum,
breaking the flow of the conformal coating material using the forward momentum to form a droplet of the conformal coating material, and
applying the droplet of the conformal coating material to the surface of the substrate.

8. The method of claim 7 further comprising coating an area on the surface by iterating steps (a) through (c).

9. The method of claim 4 wherein applying the droplet of conformal coating material has a maximum volume of 5 nanoliters.

10. The method of claim 4 further comprising iterating the steps of causing, breaking and applying at a rate of about 100 droplets per second to continuously apply the first linear pattern of conformal coating material to the substrate.

11. The method of claim 4 further comprising applying a droplet to coat a maximum area on the substrate of about 200 μm².
